(19) United States
(12) Patent Application Publication
(10) Pub. No.: US 2002/0042992 A1
(43) Pub. Date: Apr. 18, 2002

(54) Cracking mandrel for connecting rods

(76) Inventors: Glen M. Rivard, Belle River (CA); Marcus H. Girgis, Windsor (CA)

Correspondence Address: Robert L. Stearns, Reising, Ethington, Barnes, Kisselle,, Learman & McCulloch, PC, 5291 Colony Drive North, Saginaw, MI, 48603, US

(21) Appl. No.: 10/023,600

(22) Filed: Dec. 18, 2001

Related U.S. Application Data
(62) Division of application No. 09/507,809, filed on Feb. 22, 2000.

(51) Int. Cl. B23P 17/00

(52) U.S. Cl. 29/888.09

(57) ABSTRACT

The connecting rod cracking machine has a split mandrel with a lower jaw and an upper jaw. A cylindrical bore in one of the jaws receives a piston connected to the other jaw. A fluid supply passage supplies fluid under pressure to the cylindrical bore. A plurality of drain passages connect the cylindrical bore to a sump. The drain passages are closed when the piston is retracted into the bore. The drain passages are simultaneously opened upon the piston moving a fixed distance from the retracted position.

This application is a division of application Ser. No. 09/507,809, filed Feb. 22, 2000.

### BACKGROUND OF THE INVENTION

1. Technical Field

This invention relates to a cracking mandrel and process, for separating a rod cap from the rod body of a connecting rod for an internal combustion engine, employing a no-impact cracking mandrel.

2. Related Prior Art

Connecting rods for connecting pistons to the crank shaft of an internal combustion engine have a bearing at each end. A small end bearing receives a wrist pin that connects the connecting rod to a piston. A large end bearing connects the connecting rod to the crank shaft throw.

A number of manufacturing procedures are used to form connecting rods. They are cast, forged or machined. The large end bearing has a bearing cap that is connected to the rod body by bolts. Many connecting rods are formed with a rod cap integral with a rod body. The rod cap is generally separated by sawing. After the cap is separated, the mating surfaces are machined and then the rod cap is reattached by bolts. The large bearing end bore is then machined. If a rod cap is turned 180 degrees or mated with a different rod body, the rod bore is inaccurate.

A manufacturing process referred to as cracking is used, to separate rod caps from rod bodies, by a number of manufacturers. In this process, a two piece mandrel is received in the large connecting rod bore, the two mandrel pieces are then separated and tension forces crack the rod cap and separate the rod cap from the rod body. A substantial force is required to separate the rod cap using this process. The required force can be obtained, to crack a rod cap, by driving a wedge between the two mandrel pieces. This is known as impact separation because the wedge is driven by an impact.

A rod cap separated from a rod body by cracking procedures has a relatively rough mating surface. This rough mating surface ensures that the rod cap that was originally integral with a rod body is the only rod cap that can be used with that specific rod body. The rod cap must also be oriented as it was originally to work. A mating surface formed by cracking eliminates the movement of the rod cap relative to the rod body thereby creating a strong connection.

Unfortunately connecting rod cracking is not always successful. Sometimes the rod cap cracks in the wrong location. Other times there is some deformation of the material along a portion of the cracking plane that prevents the formation of a satisfactory joint. A further problem is related to tooling wear. The impact load required to crack a rod body and friction between the parts causes tooling wear. Worn tooling results in an increased quantity of

Rod cracking machines have been proposed that employ a hydraulic cylinder and piston to separate two mandrel halves. Such a system reduced impact loading of tools and friction due to sliding contact between the wedge and the mandrel halves. However, the expansion of hydraulic oil and contraction of the hydraulic conduits upon separation of the connecting rod cap transfers substantial energy to the mandrel parts and the rod assembly following separation. This excessive energy transfer and the resulting impacts prematurely wears the tooling and may damage a rod assembly.

### SUMMARY OF THE INVENTION

The connecting rod cracking machine has a mandrel assembly with a first jaw fixed to a frame. A second jaw is slideably mounted on the frame for movement toward and away from the first jaw. A cylinder and a piston are carried by the first and second jaws. A hydraulic fluid supply passage is connected to the cylinder. A fluid dump passage has a dump passage inlet that is closed by the piston when the piston is retracted into the cylinder. Upon separation of the first jaw from the second jaw a fixed distance, the dump passage is open.

Dumping hydraulic fluid to a sump just after the rod cap is separated reduces the force on the components of the cracking machine. This reduction of force reduces the energy to be absorbed by a stop and by components of the machine. The reduction and energy absorption reduces wear on machine parts and extends machine life.

### THE DRAWINGS

The presently preferred embodiment of the invention is disclosed in the following description and in the accompanying drawings, wherein:

FIG. 1 is a front elevational view of the connecting rod cracking machine and a sectional view of the mandrel assembly;

FIG. 2 is a side elevational view with parts broken away;

FIG. 3 is a top plan view;

FIG. 4 is a rear elevational view of the lower block and the upper block assembly;

FIG. 5 is a vertical sectional view of the mandrel;

FIG. 6 is a sectional view of the lower jaw taken along line 6-6 in FIG. 5;

FIG. 7 is a side elevational view of the hydraulic fluid supply assembly;

FIG. 8 is front elevational view of the hydraulic fluid supply assembly;

FIG. 9A is an upper portion of a hydraulic fluid circuit diagram; and

FIG. 9B is a lower portion of the hydraulic fluid circuit diagram.

### DETAILED DESCRIPTION OF THE

### PREFERRED EMBODIMENT

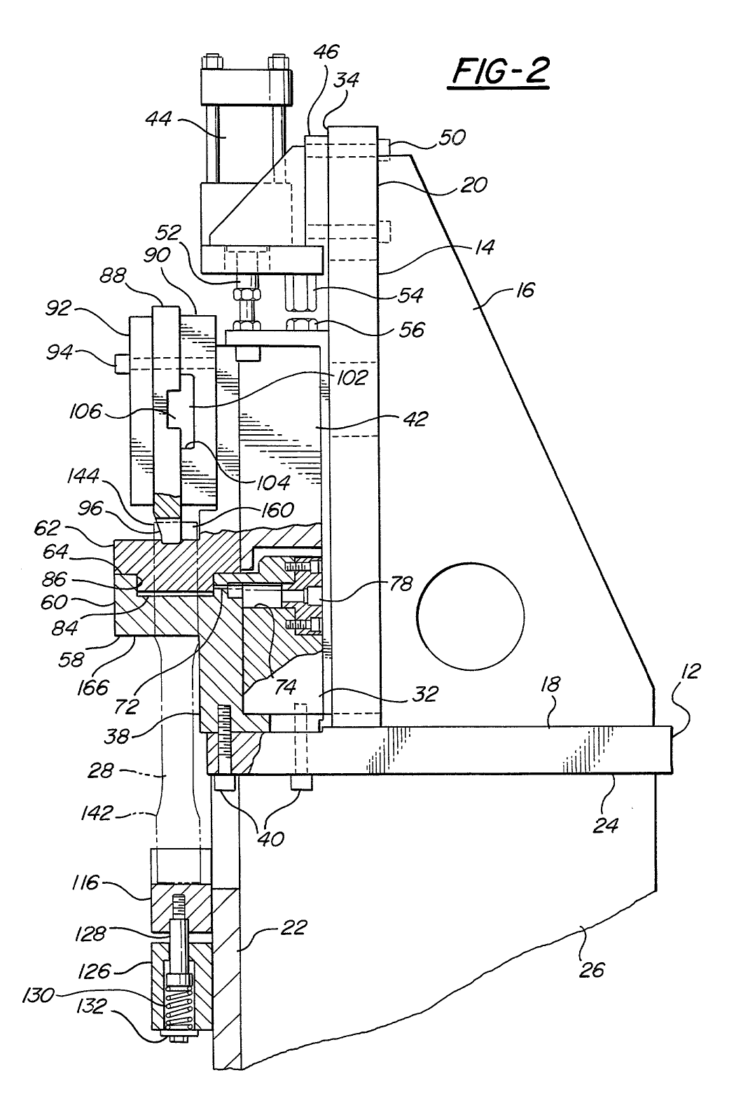

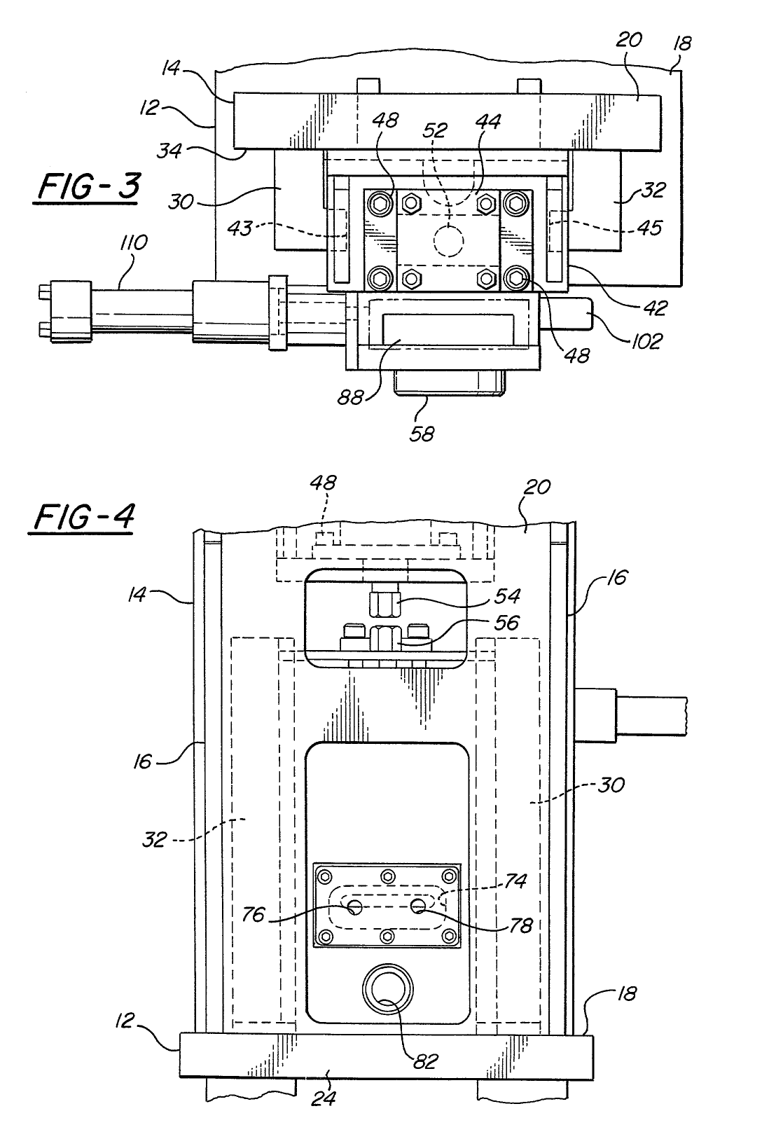

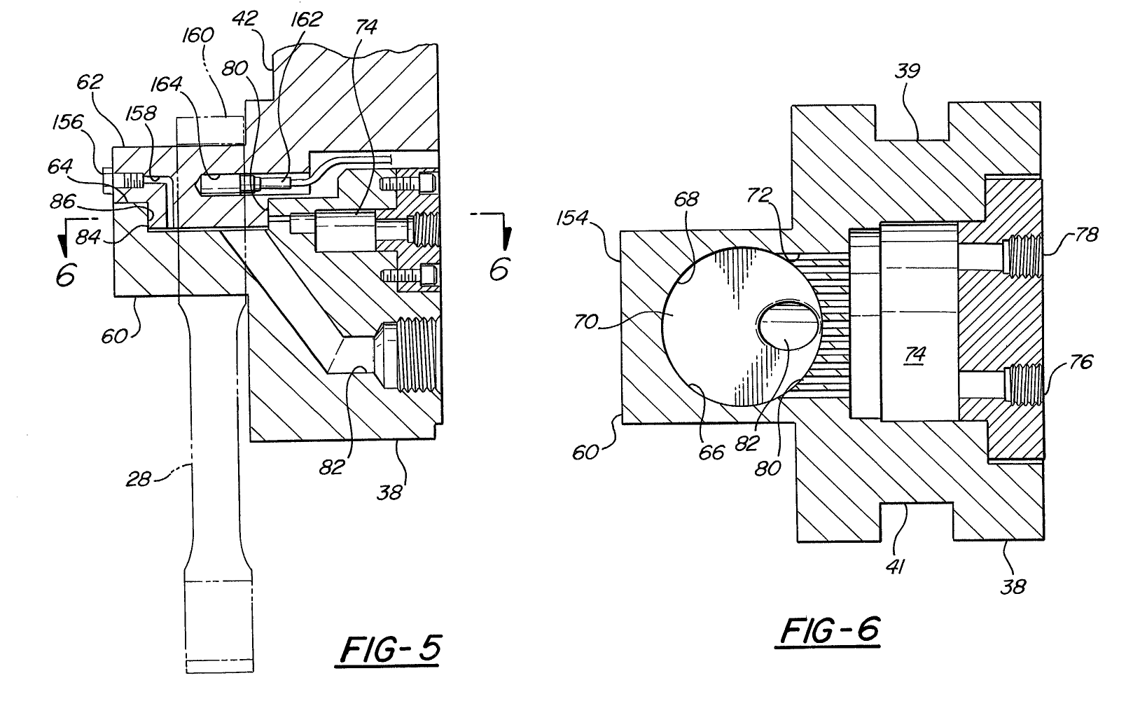

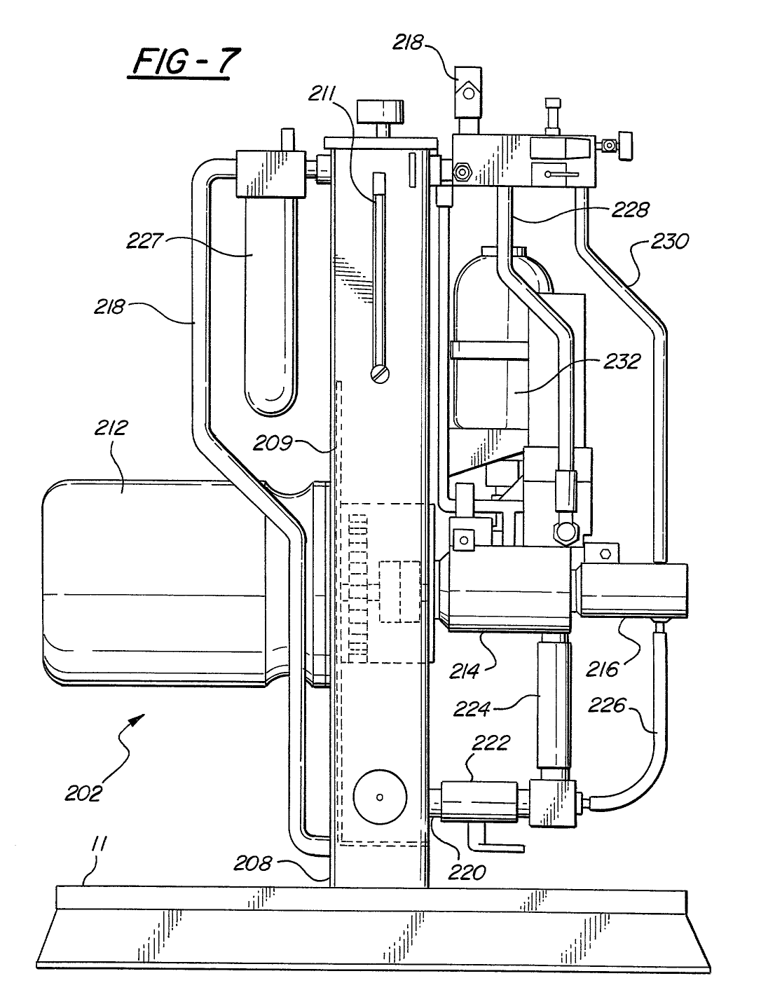

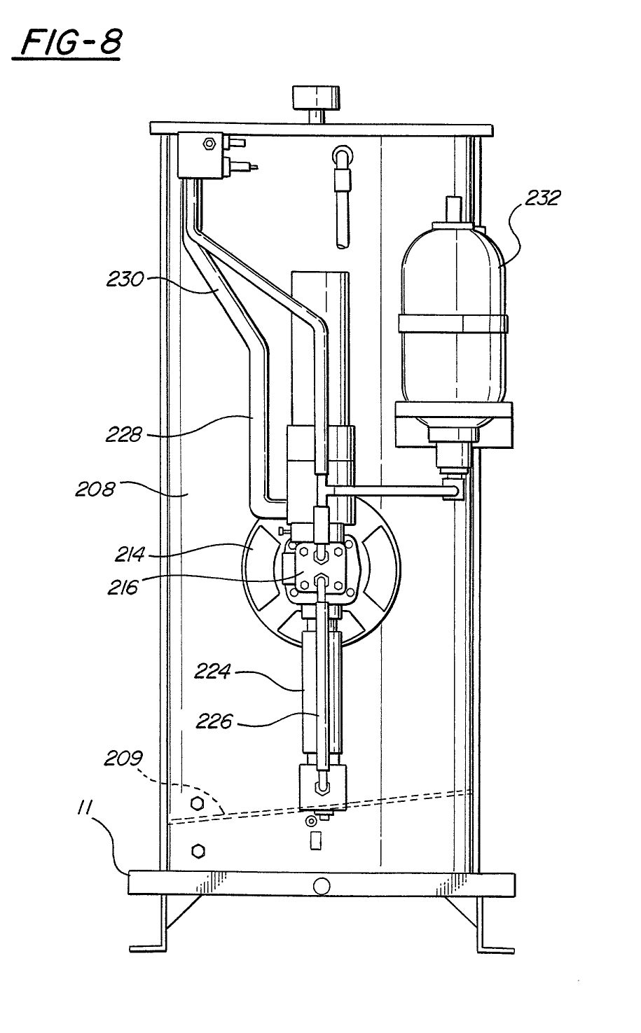

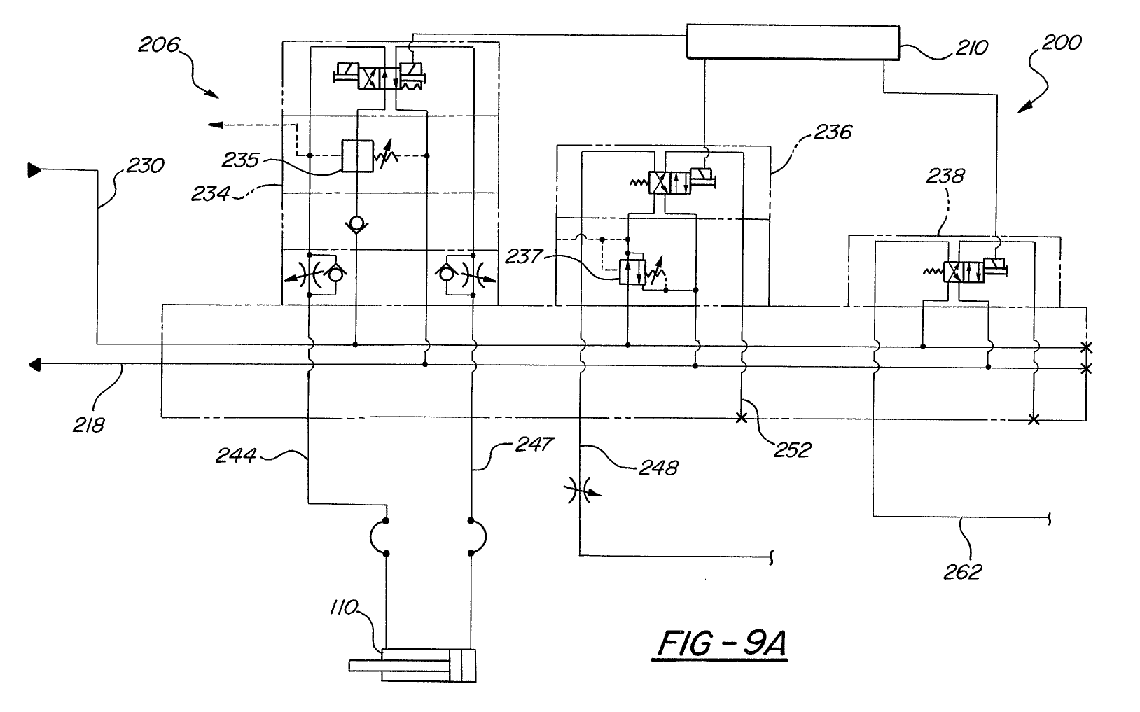

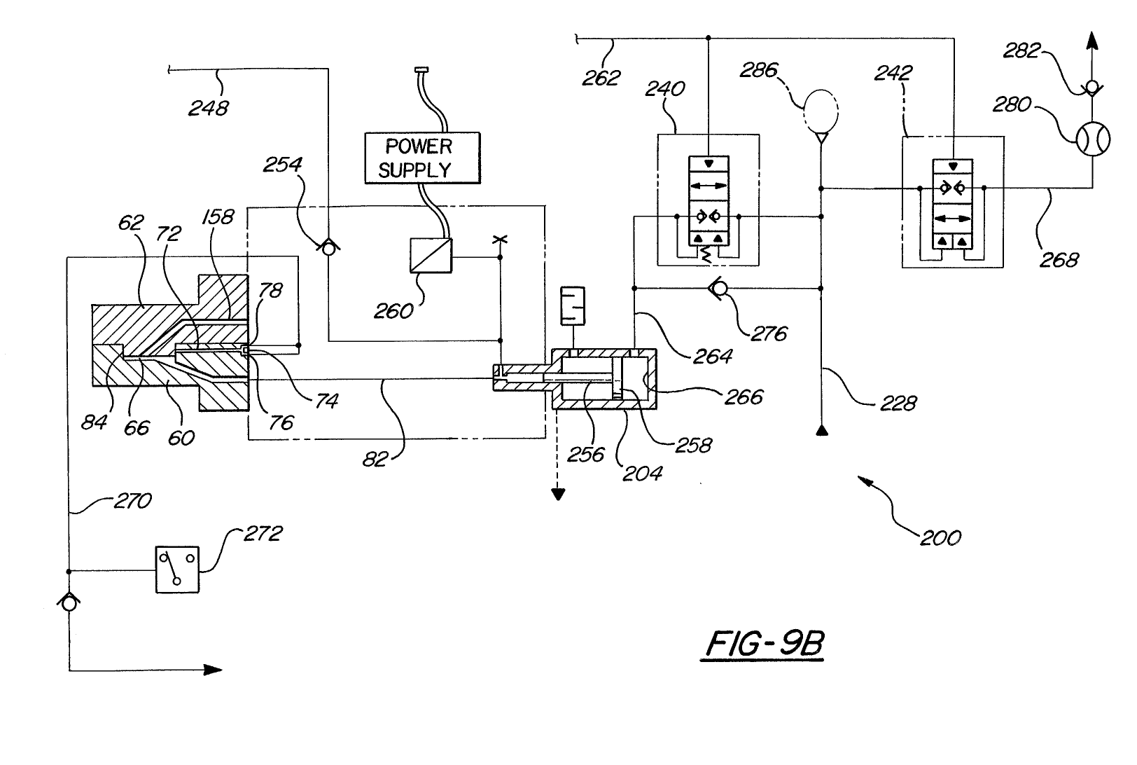

The connecting rod cap cracking machine 10 has a frame 11 with a horizontal frame plate 12 and a vertical frame plate 14. The terms vertical and horizontal describe the orientation of the parts as shown in the drawing figures. However, in the actual machine, the parts can have any desired orientation relative to the horizon. Gussets 16 are connected to the top 18 of the horizontal frame 12 and the backside 20 of the vertical frame plate 14. A second vertical frame plate 22 is secured to the bottom surface 24 of the horizontal frame plate 12. As shown in FIG. 2 the horizontal frame plate 12 is mounted on leg members 26 that also reinforce the second vertical frame plate 22. Due to the force required to crack a connecting rod 28, for an internal combustion engine, the frame 11 must be strong and rigid.

A pair of spaced apart L shaped vertical guide rails 30 and 32 are secured to the front side 34 of the vertical frame plate 14 by bolts 36. A lower block assembly 38 has a vertical slot 39 in one side and a vertical slot 41 in the other side. The rail 30 is received in the vertical slot 39. Rail 32 is received in the vertical slot 41. The lower block assembly 38 is also fixed to the horizontal frame plate 12 by bolts 40.

An upper block assembly 42 has side grooves 43 and 45 that receive the guide rails 30 and 32. An air cylinder 44 is mounted on the bracket 46 by bolts 48. The bracket 46 is clamped to the vertical frame plate 14, above the L shaped guide rails 30 and 32, by bolts 50. The piston rod 52 of the cylinder 44 is connected to the upper block assembly 42 and is operable to move the upper block assembly along the L shaped guide rails 30 and 32. The lower block assembly 38 limits downward movement of the upper block assembly 42. The stops 54 and 56 as well as the piston rod 52 are adjustable to change the lower and upper limits of travel of the upper block assembly 42.

A mandrel assembly 58 includes a lower jaw 60 that is fixed to the lower block assembly 38 and an upper jaw 62 is fixed to the upper block assembly 42. A lower jaw 60 has a horizontal upwardly facing surface 64. A cylindrical bore 66 in the lower jaw 60 has a cylindrical surface 68 with a vertical axis, and extends from the upwardly facing surface 64 to the bottom wall 70 that is parallel to the upwardly facing surface. A plurality of fluid dump passages 72 extend from the cylindrical bore 66 to a collection chamber 74. Two drain passages 76 and 78 connect the collection chamber to a sump S. The inlets 80 to the dump passages 72 are all in a horizontal plane that is perpendicular to the axis of the cylindrical surface 68. A hydraulic fluid supply passage 82, in the lower jaw 60 and lower block assembly 38, intersects the bottom wall 70 and is connected to a source of hydraulic fluid under pressure. A hydraulic fluid circuit controls the flow of hydraulic fluid into and out of the cylindrical bore 66 as explained below.

The upper jaw 62 of the mandrel assembly 58 is fixed to the upper block assembly 42 by a plurality of bolts 94. A cylindrical piston 84 is integral with the upper jaw 62, extends downwardly and is received in the cylindrical bore 66 in the lower jaw 60. A seal 86 in a groove in the piston 84 prevents leakage between the cylindrical surface 68 and the piston. This seal 86 is above the inlets 80 to the dump passages 72 when the piston 84 is at the bottom end of its range of movement. The dump passages 72 carry hydraulic fluid that leaks between the piston 84 and the cylindrical surface 68 to the sumps. This removal of hydraulic fluid protects the seal 86 from high pressure fluid.

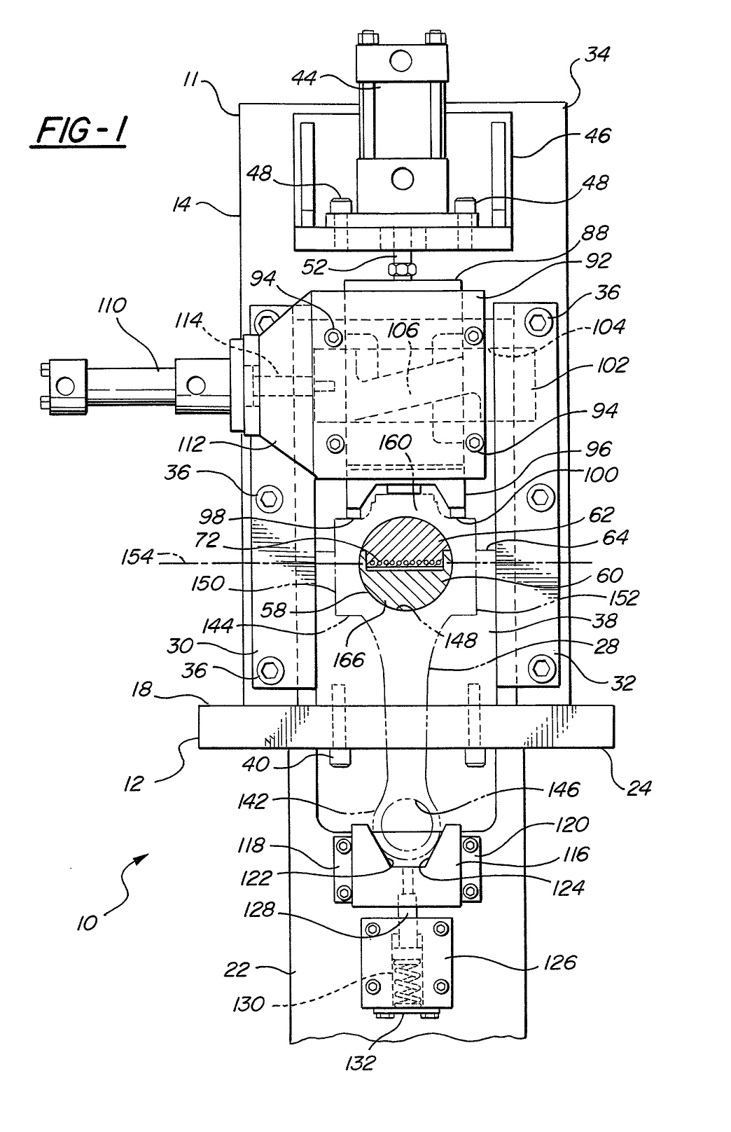

A wedge clamp 88 is vertically moveable between a base plate 90 and a cover plate 92. The base plate 90 and the cover plate 92 are both clamped to the upper block assembly 42 by bolts 94. The clamp nose 96 on the wedge clamp 88 has two spaced apart rod cap contacts surfaces 98 and 100. A wedge lock 102 is slidably mounted in a horizontal groove 104 in the base plate 90. An inclined bar 106 of the wedge lock 102 is slidably received in an incline slot 108 in the wedge clamp 88. Horizontal movement of the wedge lock 102 to the right, as shown in FIG. 1, moves the wedge clamp 88 vertically downward toward the lower block assembly 38. Horizontal movement of the wedge lock 102 to the left moves the wedge clamp 88 vertically upward and away from the lower block assembly 38. A hydraulic cylinder 110 is mounted on a cylinder bracket 112 that is fixed to the upper block assembly 42. A piston rod 114 of the cylinder 110 is attached to the wedge lock 102 and moves the wedge lock in the horizontal groove 104.

A V-block 116 is supported, on the second vertical frame plate 22 for vertical movement, by guide bars 118 and 120. The V-block 16 has two work piece contact surfaces 122 and 124 that face toward each other and extend upwardly and outwardly. A spring retainer assembly 126 is mounted on the second frame plate 22 below the V-block 116. A plunger 128, slidably mounted in the spring retainer assembly 126, is connected to the V-block 116. A compression coil spring 130, held in the spring retainer assembly 126 by cover plate 132, urges the plunger 128 upward and biases the V-block 116 toward the mandrel assembly 58.

A connecting rod 28 for an internal combustion engine has a small bearing end 142 and a large bearing end 144. The small bearing end 142 has a bore 146 that receives a wrist pin bushing. A large bearing end 144 has a large diameter bore 148 and two rod cap bolt bosses 150 and 152. Grooves may be provided in the bosses 150 and 152 to establish a cracking plane 154. The inside diameter of the bore 148 is slightly larger than the outside diameter of the mandrel assembly 58 when the piston 84 is retracted into the cylinder bore 66.

During operation of the rod cap cracking machine 10, a connecting rod 28 is mounted on the machine with a mandrel assembly 58 telescopically received in the large diameter bore 148 and the small bearing end 142 in engagement with the work piece contact surfaces 122 and 124. In this position the coil spring 130 urges the V-block 116 and the connecting rod 28 toward the fixed lower jaw 60. The upper block assembly 42 is raised by the air 62 into firm engagement with the top of the bore 148.

The hydraulic cylinder 110 is activated to move the wedge clamp 88 downward and clamp the rod cap 160 between the upper jaw 62 and the rod cap contact surfaces 98 and 100. By holding the rod cap 160 against the cap contact surfaces 98 and 100 the rod cap is prevented from pivoting and both bolts bosses 150 and 152 crack substantially simultaneously.

Hydraulic fluid is supplied to the cylinder 66 through the hydraulic fluids supply passage 82. An air bleed plug 156 in the air bleed passage 158 is provided in the jaw 62 to remove air from the cylindrical bore 66. Fluid entering the cylindrical bore 66 forces the piston 84 away from the bottom wall 70 of the cylinder and separates the upper jaw 62 from the lower jaw 60. The force exerted on the piston 84 by the hydraulic fluid cracks the connecting rod 28 along the cracking plane 154. Upon separation of the rod cap 160 from the remainder of the connecting rod 140, the piston 84 exposes the inlets 80 to the fluid dump passages 72 and hydraulic fluid is rapidly dumped from the cylinder 66. Dumping oil from the cylinder 66 reduces force on the piston 84 and the upper jaw 62. The reduction of force on piston 84 reduces the energy to be absorbed to stop upper movement of the upper block assembly 42 and reduces wear on the mandrel assembly 58. The flow of fluid through the dump passages 72 upon cracking of the connecting rod 28 is detected and the supply of fluid to the supply passage 82 is discontinued as described below.

A measuring pin assembly 162 with parts connected to the vertical frame 14 and to the bore 164 in the upper jaw 62 may be employed to detect movement of the upper jaw upon cracking of the connecting rod cap 160. However, the flow of fluid through the dump passage 72 is the preferred indicator indicating that cracking has occurred.

The lower jaw 60 of the mandrel 58 has a contact surface 166 in the large diameter rod bore 148 that extends more than 180 degrees about an axis of the mandrel assembly 58. A contact surface 166 that extends 212 degrees about the axis of the large diameter bore 148 is acceptable. As a result, the lower jaw 60 extends upward into the rod cap 160 and limits movement of the cap bolt bosses 150 and 152 toward each other. Any movements of the bosses 150 and 152, of the rod cap 60 adjacent to the cracking plane 154, toward each other will increase the upward force on the rod cap.

The connecting rod cap cracking machine 10 is operated hydraulically by a hydraulic system 200. The hydraulic system includes a pump assembly 202, a pressure intensifier 204, a control valve system 206, a fluid reservoir 208 and an electric valve control system 210. The reservoir 208 has an internal baffle 209 for cooling and an oil level sight tube 211. The pump assembly 202 has an electric motor 212 mounted on the frame 11. The motor 212 drives a medium pressure pump 214 and a low pressure pump 216. Both pumps 214 and 216 receive hydraulic fluid from the reservoir or tank 208 through line 220, a valve 222 and lines 224 and 226. The tank 208 receives fluids through a fluid return line 218. A filter 227 is provided in the fluid return line 218. Medium pressure fluid is discharged from the medium pressure pump 214 through a medium pressure supply line 228. Low pressure fluid is discharged from the low pressure pump 216 through a low pressure supply line 230. An accumulator 232 is provided in the low pressure supply line 230.

The control valve system 206 includes a fixture clamp solenoid valve 234, a low pressure advance fracture solenoid valve 236, a pressure advance fracture solenoid valve 238, a first cracking pressure pilot valve 240 and a second cracking pressure pilot valve 242. The solenoid valve 234 is connected to the low pressure supply line 230, the fluid return line 218 and to a hydraulic cylinder 110 that moves the wedge lock 102 described above. In a first position, the valve 234 directs fluid to the cylinder 110 through line 244, retracts the piston rod 246 and lifts the wedge clamp 88. The head end of the cylinder 110 is connected to the fluid return line 218 by a line 247 when the valve 234 is in the workpiece loading position. In a working position, the solenoid valve 234 connects line 244 to the return line 218 and connects the line 247 to the low pressure supply line 230 to extend the piston rod 246. Extending the piston rod 246 moves the wedge clamp 88 downward and clamps the rod cap 160 to the upper jaw 62 of the mandrel 58.

The low pressure advance fracture solenoid valve 236 is connected to the low pressure supply line 230, the fluid return line 218 and to the fluid supply passage 82 by a line 248. The fluid supply passage 82 connects the fluid pressure intensifier 204 to the cylindrical bore 66. In a non-energized position the solenoid valve 236 connects the line 248 to the fluid return line 218 and connects the low pressure supply line 230 to a line 252 without an outlet. In an energized position the valve 236 connects the line 252 to the fluid return line 218 and connects the low pressure supply line 230 to the line 248. Fluid supplied to the line 248 passes through a check valve 254, into the fluid supply passage 82, forces the pistons 256 and 258 to the right as shown in the drawing, and separates the jaws 60 and 62 of the mandrel 58. Separating the jaws 60 and 62 with low pressure fluid pre-loads the mandrel 58. A further pre-load on the mandrel 58 is obtained by retracting the piston rod 52 of the air cylinder 44. The pressure transistor 260 monitors the pressure in the fluid supply passage 82, cylindrical bore 66 and on the piston 256.

The fixture clamp solenoid valve 234 includes a pressure control valve 235. The low pressure advance fracture solenoid valve 236 includes a pressure control valve 237. The pressure control valves 235 and 237 control the pressure of fluid supplied by the two solenoid valves 234 and 236.

The high pressure advance fracture solenoid valve 238 connects the low pressure supply line 230 to the supply line 262 when energized by the electric valve control system 210. The supply line 262 supplies low pressure fluid to the first and second cracking pressure pilot valves 240 and 242. The fluid in line 262 opens the pilot valve 240 and simultaneously, or shortly thereafter, closes pilot valve 242. The accumulator 232 ensures that both pilot valves 240 and 242 are shifted substantially simultaneously. Opening the pilot valve 240 connects the medium pressure supply line 228 to a supply line 264. The line 264 supplies medium pressure hydraulic fluid to a cylindrical chamber 266 of the pressure intensifier 204 where it acts on a large diameter piston 258. The small diameter piston 256 supplies fluid at a higher pressure to the cylindrical bore 66. The piston 84 is forced upward raising the upper jaws 62 and fracturing the connecting rod gap 160. Closing the second cracking pressure pilot valve 242 stops the flow of fluid from the medium pressure supply line 228 to the tank 208 through line 268 which is connected to fluid return line 218. When the pilot valve 242 is closed, the entire output of the medium pressure pump 214 is directed to the pressure intensifier 204.

Upon the connecting rod cap, 160 fracturing, fluid in the cylinder 66 is dumped into the collection chamber 74 through the fluid dump passages 72. Fluid is discharged from the chamber 74 through drain passages 76 and 78 and pipe 270 which is connected to the fluid return line 218 and to the tank 208. A pressure switch 272 detects the flow of fluid in the pipe 270 upon fracture of the rod cap 160. An electric signal generated by the pressure switch 272 causes an electronic valve control system 210 to deenergize the high pressure advance fracture solenoid 238. This connects the supply line 262 to the fluid return line 218. The second pilot valve 242 opens and directs fluid from the supply line 228 and the pump 214 to the tank 208 through line 268. The first pilot valve 240 closes. Fluid in the cylindrical chamber 266 can be forced from the pressure intensifier 204 through a one way valve 276 and to the tank 208 through the line 268. The air cylinder 44 is extended to force the piston 84 into the cylindrical bore 66, and retract the pistons 256 and 258 after the first pilot valve 240 is closed. Fluid in the intensifier 204 is forced through the one way valve 276. Medium pressure fluid in the supply line 228 biases the first pilot valve 240 toward a closed position and biases the second pilot valve 242 toward an open position.

A flow meter 280 in the line 268 measures the flow rate of fluid from the medium pressure pump 214 when the pilot valve 242 is open. The relief valve 282 prevents back flow through the line 268 when the valve 242 is opened. The flow meter 280 does not measure any flow during the time the pilot valve 242 is closed. The time during which the pilot valve 242 is closed is substantially equal to the time required to crack a connecting rod cap 160. By comparing the fluid flow rate from the medium pressure pump 214, the maximum pressure in the cylindrical bore 66 as measured by the pressure transistor 260 and the time period required to crack a connecting rod cap 160 as measured in the flow meter 280 with a measured standard connecting rod 28 with unsatisfactory strength can be identified.

The pilot operated valves 240 and 242 could be replaced by solenoid operated valves it desired. When solenoid valves are used in place of the pilot valves 240 and 242, the solenoid valve 238 can be eliminated. Solenoid valves that operate at a medium pressure of 2,000 psi are more expensive and can be somewhat more difficult to synchronize. Synchronization between the valves 240 and 242 is desirable to eliminate pressure spikes and insure smooth operation of the cracking machine.

An accumulator 286 can be connected to the line 286 to insure that there is sufficient fluid to operate the pressure intensifier 204 rapidly. With an accumulator 286 the size of the medium pressure pump 214 can be decreased. With a smaller medium pressure pump, the quantity of oil pumped to the fluid reservoir can be reduced.

The disclosed embodiment is representative of a presently preferred form of the invention, but is intended to be illustrative rather than definitive thereof. The invention is defined in the following claims.

What is claimed is:

1. A method of cracking a connecting rod to separate a rod cap from a connecting rod body comprising: inserting a mandrel assembly having an upper jaw and a lower jaw into a large bearing bore through said connecting rods; urging the rod cap toward the upper jaw; urging a small bearing end of said connecting rod toward the lower jaw; pressurizing a hydraulic cylinder to separate the upper jaw from the lower jaw; and dumping oil from the hydraulic cylinder upon separation of the rod cap from the connecting rod body and prior to a stop limiting further separation of the upper jaw from the lower jaw.

2. A method of cracking a connecting rod to separate a rod cap from a connecting rod body as set forth in claim 1 including uncovering a plurality of inlets to a plurality of fluid dump passages.

3. A method of cracking a connecting rod to separate a rod cap from a connecting rod body as set forth in claim 1 including sensing the dumping of oil from the hydraulic cylinder and stopping the flow of oil for pressurizing the hydraulic cylinder.
